(19) United States
(12) Patent Application Publication
(10) Pub. No.: US 2023/0155641 A1
(43) Pub. Date: May 18, 2023

(54) METHOD AND DEVICE FOR INDICATING DATA TRANSMISSION IN COMMUNICATION SYSTEM SUPPORTING MULTIPLE LINKS

(71) Applicants: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(21) Appl. No.: 17/923,050

(22) PCT Filed: Apr. 29, 2021
(86) PCT No.: PCT/KR2021/005446

§ 371 Date: Nov. 3, 2022

(30) Foreign Application Priority Data
May 4, 2020 (KR) 10-2020-0053445

(51) Int. Cl. H04B 7/0452; H04L 5/00; H04W 56/00

(52) U.S. Cl. CPC H04B 7/0452; H04L 5/0055; H04W 56/001

(57) ABSTRACT

Disclosed are a method and a device for indicating data transmission in a communication system supporting multiple links. A first device operating method comprises: generating a data frame including first information indicating a communication method in multiple links including a first link and a second link; transmitting the data frame to a second device in the multiple links; and receiving an ACK frame for the data frame from the second device in one or more links from among the multiple links.

### CROSS-REFERENCE TO RELATED APPLICATIONS

This application is a U.S. national stage of International Application No. PCT/KR2021/005446, filed on Apr. 29, 2021, which claims priority to Korean Patent Application No. 10-2020-0053445 filed on May 4, 2020, the entire disclosures of which are incorporated by reference herein in its entirety.

### TECHNICAL FIELD

The present disclosure relates to a wireless local area network (LAN) communication technique, and more particularly, to a technique for simultaneously transmitting data in multiple links.

### BACKGROUND

Recently, as the spread of mobile devices expands, a wireless local area network technology capable of providing fast wireless communication services to mobile devices is in the spotlight. The wireless local area network (LAN) technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). The initial version of the IEEE 802.11 standard can support a communication speed of 1 to 2 megabits per second (Mbps). The later versions of the IEEE 802.11 standard are being standardized in the direction of improving the communication speed.

The revised version of the IEEE 802.11a standard can support a communication speed of up to 54 Mbps using an orthogonal frequency division multiplexing (OFDM) scheme in a 5 giga hertz (GHz) band. The IEEE 802.11b standard utilizes a direct sequence spread spectrum (DSSS) scheme to support a communication speed of up to 11 Mbps in a 2.4 GHz band where the initial version operates.

The IEEE 802.11n standard supporting a high throughput (HT) wireless LAN technology has been developed due to the demand for higher speed. The IEEE 802.11n standard may support the OFDM scheme. By supporting channel bandwidth expansion techniques and multiple input multiple output (MIMO) techniques in the IEEE 802.11n standard, the maximum communication speeds in the 2.4 GHz band and the 5 GHz band can be improved. For example, the IEEE 802.11n standard can support a communication speed of up to 600 Mbps by using 4 spatial streams and a 40 MHz bandwidth.

As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11ac standard may be a very high throughput (VHT) wireless LAN technology supporting a high throughput of 1 gigabit per second (Gbps) or more. The IEEE 802.11ac standard can support downlink transmission for multiple stations by utilizing the MIMO techniques.

As the demand for wireless LAN technologies further increases, the IEEE 802.11ax standard has been developed to increase a frequency efficiency in a dense environment. In the IEEE 802.11ax standard, a communication procedure may be performed using multi-user (MU) orthogonal frequency division multiple access (OFDMA) techniques. In the IEEE 802.11ax standard, uplink communication may be performed using the MU MIMO techniques and/or OFDMA techniques.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since the multi-link operation is an operation that is not defined in the existing wireless LAN standard, it may be necessary to define detailed operations according to the environment in which the multi-link operation is performed. In order to transmit data through a multi-link, a channel access method may need to be performed in each link of the multi-link. Simultaneous transmit and receive (STR) operations in the multi-link may not be performed depending on the performance of a communication node (e.g., access point, station, or device). A multi-link operation for transmitting data in this situation may be needed.

Meanwhile, the technologies that are the background of the present disclosure are written to improve the understanding of the background of the present disclosure and may include content that is not already known to those of ordinary skill in the art to which the present disclosure belongs.

### SUMMARY

### Technical Problem

The present disclosure is directed to providing a method and an apparatus for transmitting and receiving data using a multi-link in a wireless local area network (LAN) system.

### Technical Solution

An operation method of a first device, according to a first embodiment of the present disclosure for achieving the above-described objective, may comprise: generating a data frame including first information indicating a communication scheme in a multi-link including a first link and a second link; transmitting the data frame to a second device in the multi-link; and receiving an acknowledgment (ACK) frame for the data frame from the second device in one or more links of the multi-link.

The communication scheme may indicate an independent transmission scheme or a synchronization transmission scheme, a communication operation may be performed independently in each link of the multi-link when the independent transmission scheme is used, and synchronous communication operations may be performed in the multi-link when the synchronization transmission scheme is used.

The synchronization transmission scheme is classified into a synchronous simultaneous transmit and receive (STR) scheme and a synchronous non-STR scheme, STR operations may be performed in the multi-link when the synchronous STR scheme is used, and the STR operations may not be performed in the multi-link when the synchronous non-STR scheme is used.

The data frame may further include second information indicating one or more links of the multi-link in which the data frame is transmitted.

The first information and the second information may be included in an extremely high throughput (EHT) control field of a medium access control (MAC) header of the data frame.

When a combination of a value of a type field and a value of a subtype field included in the MAC header of the data frame is a first value, the MAC header may include the EHT control field.

The ACK frame may include third information indicating one or more links of the multi-link in which the data frame is received.

The ACK frame may further include an identifier (ID) of each of the one or more links indicated by the third information.

The operation method may further comprise, when the third information indicates that the data frame is received in the first link and the data frame is not received in the second link, transmitting a data frame including retransmission data for the second link in the first link.

An operation method of a second device, according to a second embodiment of the present disclosure for achieving the above-described objective, may comprise: receiving a data frame from a first device in one or more links of a multi-link including a first link and a second link; generating an ACK frame including third information indicating the one or more links in which the data frame is received; and transmitting the ACK frame to the first device in the one or more links.

The data frame may include first information indicating a communication scheme in the multi-link and second information indicating one or more links of the multi-link, in which the data frame is transmitted.

The communication scheme indicates an independent transmission scheme or a synchronization transmission scheme, a communication operation may be performed independently in each link of the multi-link when the independent transmission scheme is used, and synchronous communication operations may be performed in the multi-link when the synchronization transmission scheme is used.

The first information and the second information may be included in an extremely high throughput (EHT) control field of a medium access control (MAC) header of the data frame.

The ACK frame may further include an identifier (ID) of each of the one or more links indicated by the third information.

The operation method may further comprise, when the third information indicates that the data frame is received in the first link and the data frame is not received in the second link, receiving, from the first device, a data frame including retransmission data for the second link in the first link.

A first device, according to a third embodiment of the present disclosure for achieving the above-described objective, may comprise: a processor and a memory storing one or more instructions executable by the processor. The one or more instructions are executed to: generate a data frame including second information indicating one or more links of a multi-link, in which the data frame is transmitted, the multi-link including a first link and a second link; transmit the data frame to a second device in the one or more links indicated by the second information; and receive an ACK frame for the data frame from the second device in at least one link of the multi-link.

The data frame may further include first information indicating a communication scheme in the multi-link. The communication scheme indicates an independent transmission scheme or a synchronization transmission scheme. A communication operation may be performed independently in each link of the multi-link when the independent transmission scheme is used. Synchronous communication operations may be performed in the multi-link when the synchronization transmission scheme is used.

The first information and the second information may be included in an extremely high throughput (EHT) control field of a medium access control (MAC) header of the data frame.

The ACK frame may include third information indicating one or more links of the multi-link, in which the data frame is received.

The one or more instructions may be further executed to, when the third information indicates that the data frame is received in the first link and the data frame is not received in the second link, transmit a data frame including retransmission data for the second link in the first link.

### Advantageous Effects

According to the present disclosure, during communication between a first MLD and a second MLD, the first MLD may inform the second MLD of information on data transmitted through another link. For error correction in another link, a device (e.g., first MLD and/or second MLD) may wait for an ACK transmission timeout. Alternatively, the device may quickly correct an error using another link without performing a continuous retransmission operation. Therefore, communication efficiency can be improved in the wireless LAN system.

### DESCRIPTION OF DRAWINGS

FIG. 1 is a block diagram illustrating a first embodiment of a communication node constituting a wireless local area network (LAN) system.

FIG. 2 is a conceptual diagram illustrating a first embodiment of multi-links configured between multi-link devices (MLDs).

FIG. 3 is a sequence chart illustrating a first embodiment of a negotiation procedure for a multi-link operation in a wireless LAN system.

FIG. 4A is a conceptual diagram illustrating a first communication scenario using a multi-link.

FIG. 4B is a conceptual diagram illustrating a second communication scenario using a multi-link.

FIG. 5A is a timing diagram illustrating a first embodiment of a communication method using a multi-link in a wireless LAN system.

FIG. 5B is a timing diagram illustrating a second embodiment of a communication method using a multi-link in a wireless LAN system.

FIG. 6A is a timing diagram illustrating a first embodiment of a communication method based on the synchronization transmission scheme in a wireless LAN system.

FIG. 6B is a timing diagram illustrating a second embodiment of a communication method based on the synchronization transmission method in a wireless LAN system.

FIG. 7A is a timing diagram illustrating a first embodiment of a communication method based on the independent transmission scheme in a wireless LAN system.

FIG. 7B is a timing diagram illustrating a second embodiment of a communication method based on the independent transmission scheme in a wireless LAN system.

FIG. 8A is a timing diagram illustrating a third embodiment of a communication method using a multi-link in a wireless LAN system.

FIG. 8B is a timing diagram illustrating a fourth embodiment of a communication method using a multi-link in a wireless LAN system.

FIG. 9 is a block diagram illustrating a first embodiment of a data frame including information indicating transmission states of a multi-link in a wireless LAN system.

FIG. 10 is a block diagram illustrating a first embodiment of a BA frame including information indicating reception states of a multi-link in a wireless LAN system.

### DETAILED DESCRIPTION

Since the present disclosure may be variously modified and may have several forms, specific embodiments are shown in the accompanying drawings and be described in detail in the detailed description. It should be understood, however, that it is not intended to limit the present disclosure to the specific embodiments. On the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named as a second component without departing from the scope of the present disclosure, and the second component may also be similarly named as the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings consistent with contextual meanings in the art. In this description, unless defined clearly, terms are not necessarily construed as having formal meanings.

Hereinafter, forms of the present disclosure are described in detail with reference to the accompanying drawings. In describing the disclosure, to facilitate the entire understanding of the disclosure, like numbers refer to like elements throughout the description of the figures and the repetitive description thereof has been omitted.

In the following, a wireless communication system to which embodiments according to the present disclosure are applied is described. The wireless communication system to which the embodiments according to the present disclosure are applied is not limited to the contents described below, and the embodiments according to the present disclosure can be applied to various wireless communication systems. A wireless communication system may be referred to as a ‘wireless communication network’.

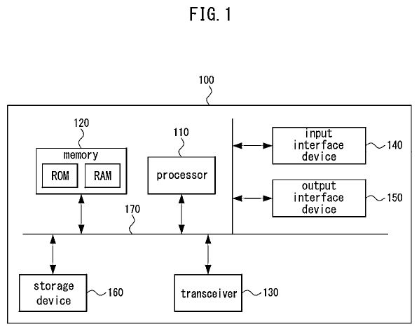

FIG. 1 is a block diagram illustrating a first embodiment of a communication node constituting a wireless LAN system.

As shown in FIG. 1, a communication node 100 may be an access point, a station, an access point (AP) multi-link device (MLD), or a non-AP MLD. The access point may refer to an AP, and the station may refer to a STA or a non-AP STA. The operating channel width supported by the access point may be 20 megahertz (MHz), 80 MHz, 160 MHz, or the like. The operating channel width supported by the station may be 20 MHz, 80 MHz, or the like.

The communication node 100 may include at least one processor 110, a memory 120, and a plurality of transceivers 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, or the storage device 160 through a dedicated interface.

The processor 110 may execute at least one instruction stored in at least one of the memory 120 or the storage device 160. The processor 110 may refer to a central processing unit (CPU), a graphics processing unit (GPU), or a dedicated processor on which the methods according to the embodiments of the present invention are performed. Each of the memory 120 and the storage device 160 may be configured as at least one of a volatile storage medium or a nonvolatile storage medium. For example, the memory 120 may be configured with at least one of a read only memory (ROM) or a random access memory (RAM).

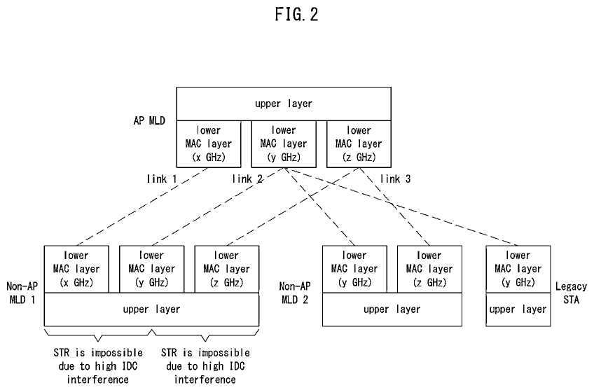

FIG. 2 is a conceptual diagram illustrating a first embodiment of multi-links configured between MLDs.

As shown in FIG. 2, an MLD may have one medium access control (MAC) address. In embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) (STA(s)) affiliated with the non-AP MLD may have different MAC addresses. Each of the APs having different MAC addresses may be in charge of each link among multiple links supported by the AP MLD and may perform a role of an independent AP.

Each of the STAs having different MAC addresses may be in charge of each link among multiple links supported by the non-AP MLD and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links (i.e., multi-link) by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band and may perform communications using a 160 MHz bandwidth according to a channel expansion scheme in a 5 GHz band. The MLD may perform communications using a 160 MHz bandwidth in the 5 GHz band and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, the respective links may be referred to as a link 1, a link 2, and a link 3. A link number may be set by the AP, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between the link 1 and the link 2 in the frequency domain) is sufficient, the MLD may perform an STR operation. For example, the MLD may transmit a physical layer convergence procedure (PLCP) protocol data unit (PPDU) 1 using the link 1 among multiple links and may receive a PPDU 2 using the link 2 among multiple links. On the other hand, if the MLD performs the STR operation when the band separation between multiple links is insufficient, in-device coexistence (IDC) interference, which is interference between the multiple links, may occur. Therefore, when the band separation between multiple links is not sufficient, the MLD may not be able to perform the STR operation.

For example, a multi-link including a link 1, a link 2, and a link 3 may be configured between the AP MLD and the non-AP MLD 1. If the band separation between the link 1 and the link 3 is sufficient, the AP MLD may perform an STR operation using the link 1 and the link 3. In other words, the AP MLD may transmit a frame using the link 1 and may receive a frame using the link 3. If the band separation between the link 1 and the link 2 is not sufficient, the AP MLD may not be able to perform an STR operation using the link 1 and the link 2. If a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a STA and an AP.

A device (e.g., AP or STA) supporting a multi-link may be referred to as a multi-link device (MLD). An AP supporting a multi-link may be referred to as an AP MLD, and a STA supporting a multi-link may be referred to as a non-AP MLD or STA MLD. The AP MLD may have a physical address (e.g., MAC address) for each link. The AP MLD may be implemented as if an AP in charge of each link exists separately. A plurality of APs may be managed within one AP MLD. Accordingly, coordination between the plurality of APs belonging to the same AP MLD may be possible. The STA MLD may have a physical address (e.g., MAC address) for each link. The STA MLD may be implemented as if an STA in charge of each link exists separately. A plurality of STAs may be managed within one STA MLD. Accordingly, coordination between the plurality of STAs belonging to the same STA MLD may be possible.

For example, an AP1 of the AP MLD and a STA1 of the STA MLD may each be in charge of a first link and may communicate using the first link. An AP2 of the AP MLD and a STA2 of the STA MLD may each be in charge of a second link and may communicate using the second link. The STA2 may receive state change information for the first link in the second link. In this case, the STA MLD may collect information (e.g., state change information) received from each link, and may control operations performed by the STA1 based on the collected information.

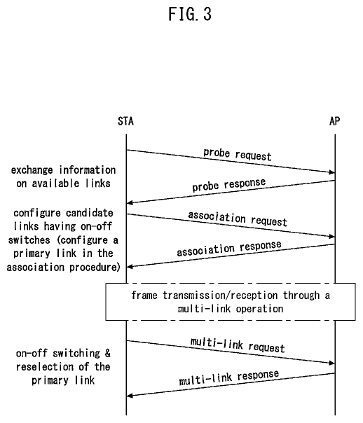

FIG. 3 is a sequence chart illustrating a first embodiment of a negotiation procedure for a multi-link operation in a wireless LAN system.

As shown in FIG. 3 an access procedure between an STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step and may perform the association step with the selected AP. In other words, the STA may transmit an association request frame to the selected AP and may complete the association with the AP by receiving an association response frame that is a response to the association request frame from the selected AP.

Meanwhile, a multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between an STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP. Also, information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

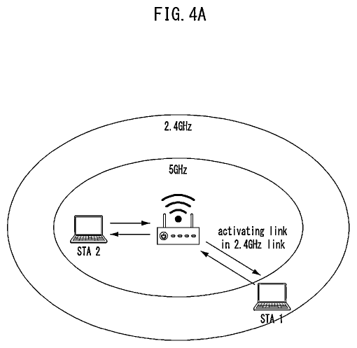

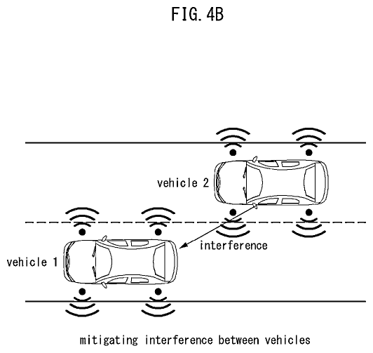

FIG. 4A is a conceptual diagram illustrating a first communication scenario using a multi-link, and FIG. 4B is a conceptual diagram illustrating a second communication scenario using a multi-link.

As shown in FIGS. 4A and 4B, a frame may be transmitted through a multi-link. In the first communication scenario shown in FIG. 4A, a frequency band of each link of the multi-link may be different. In this case, a transmission area according to each link of the multi-link may be different. For example, a frequency band of a first link of the multi-link may be a 2.4 GHz band, and a frequency band of a second link of the multi-link may be a 5 GHz band.

A STA MLD may perform a multi-link configuration operation with an AP MLD by using a primary link. A frequency band(s) available for the multi-link may be a 2.4 GHz band, a 5 GHz band, and/or a 6 GHz band. A transmission distance may be shortened as a frequency increases. Therefore, the transmission distance may be the longest in a link using the 2.4 GHz band (hereinafter referred to as a ‘2.4 GHz link’). The multi-link configuration operation may be performed in the 2.4 GHz link, and a multi-link operation may be performed in the 2.4 GHz link and a link using the 5 GHz band (hereinafter, referred to as a ‘5 GHz link’). Since a communicable distance of the 2.4 GHz link is different from a communicable distance of the 5 GHz link, communication may be performed in the 2.4 GHz band, but communication in the 5 GHz band may not be possible depending on a position of a device (e.g., AP MLD, STA MLD, AP, STA). In embodiments, the multi-link operation may mean a ‘transmission/reception operation using multiple links’. In embodiments, the device may refer to an AP MLD, STA MLD, AP, and/or STA.

In the second communication scenario shown in FIG. 4B, a multi-link configuration in each of vehicles (e.g., users of the vehicles) may be different. A vehicle 1 may use the 2.4 GHz band and the 5 GHz band, and a vehicle 2 may use the 5 GHz band and the 6 GHz band. Depending on a driving situation, the vehicle 1 and the vehicle 2 may be located in a short distance. If the distance between the vehicle 1 and the vehicle 2 becomes close while the vehicle 1 is performing communication using the multi-link, the communication may not be smoothly performed in the 5 GHz link because interference occurs in the 5 GHz link. In this case, frame transmission in the link allocated for transmission may fail.

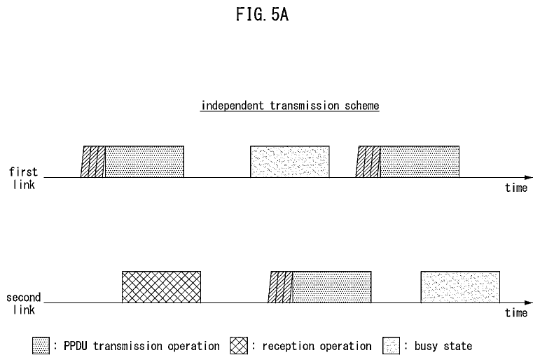

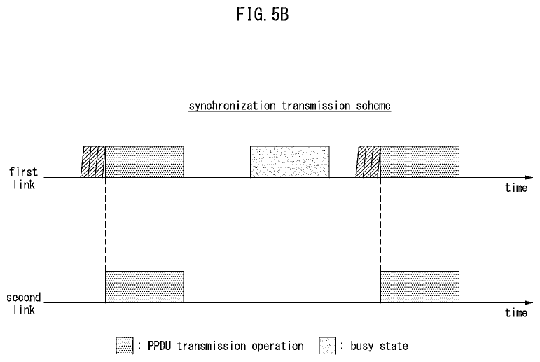

FIG. 5A is a timing diagram illustrating a first embodiment of a communication method using a multi-link in a wireless LAN system, and FIG. 5B is a timing diagram illustrating a second embodiment of a communication method using a multi-link in a wireless LAN system.

As shown in FIG. 5A, a device (e.g., AP MLD, STA MLD, AP, STA) may perform an independent channel access procedure in each link of the multi-link (e.g., first link and second link). When the channel access procedure is successful in the first link, the device may transmit and receive frames in the first link. In other words, the frame transmission/reception procedure may be performed only in a link where the channel access procedure is successful. The embodiment shown in FIG. 5A may be referred to as an ‘independent transmission scheme’.

As shown in FIG. 5B, a device may perform a channel access procedure in only one link (e.g., first link or second link) of the multi-link. For example, while the channel access procedure is performed in the first link, the device may identify an idle state of the second link, which is another link, for a preset period (e.g., point coordination function (PCF) interframe space (PIFS)). If the channel access procedure is successful in the first link and the state of the second link is idle for the preset period, the device may transmit frames simultaneously in the multi-link. In addition, the transmission operations of frames in the multi-link may be terminated at the same time. The embodiment shown in FIG. 5B may be referred to as a ‘synchronization transmission scheme’.

When the independent transmission scheme is used, a reception operation may be performed in another link(s) while a transmission operation is being performed in one link. Therefore, a device supporting the STR operations may operate according to the independent transmission scheme. Even when the device supports the independent transmission scheme and the STR operation, the STR operation may not be possible if mutual interference occurs between the links.

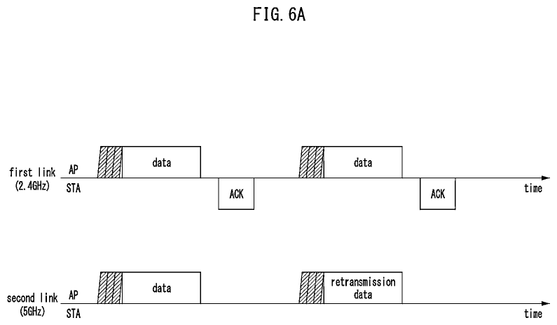

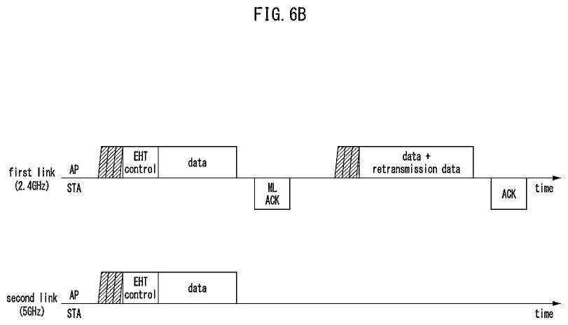

FIG. 6A is a timing diagram illustrating a first embodiment of a communication method based on the synchronization transmission scheme in a wireless LAN system, and FIG. 6B is a timing diagram illustrating a second embodiment of a communication method based on the synchronization transmission method in a wireless LAN system.

As shown in FIGS. 6A and 6B, a device may perform communication according to the synchronization transmission scheme in the multi-link. In the embodiment shown in FIG. 6A, an AP may simultaneously transmit data frames in the first link and the second link based on the synchronization transmission scheme. The frequency band of the first link may be the 2.4 GHz band, and the frequency band of the second link may be the 5 GHz band. In this case, the communicable distance of the first link may be longer than the communicable distance of the second link. Depending on a position of a STA receiving the data frame, a data frame may be successfully received by the STA without an error in the first link, but a data frame may not be received by the STA in the second link.

In the embodiment shown in FIG. 6A, the STA may receive the data frame from the AP in the first link and may transmit an acknowledgement (ACK) frame (or block ACK (BA) frame) for the data frame to the AP. The BA frame may be transmitted when a block ACK request (BAR) frame is received from the AP. Alternatively, when an immediate response ACK policy is used, the BA frame may be transmitted without transmission of the BAR frame. When the ACK frame for the data frame is received in the first link, the AP may determine that the data frame has been successfully received by the STA.

The STA may not receive the data frame from the AP in the second link and thus may not be able to transmit an ACK frame (or BA frame) to the AP. When the ACK frame for the data frame is not received in the second link, the AP may determine that the reception of the data frame has failed at the STA. In this case, the AP may retransmit the data frame after a preset time (e.g., SIFS, PIFS, or a time until a start of data transmission in the first link). The data frame retransmission operation may be performed a preset number of times. If an ACK frame for the data frame is not received even when the data frame is retransmitted the preset number of times, the AP may determine that the data frame transmission has failed and may stop the data frame retransmission operation.

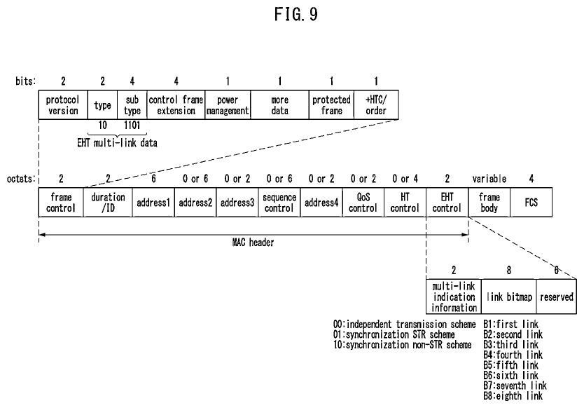

In the embodiment shown in FIG. 6B, a MAC header of the data frame transmitted through the multi-link may include an Extreme High Throughput (EHT) control field. The EHT control field may include multi-link indication information and a link bitmap. Here, each of the multi-link indication information and the link bitmap may be multi-link indication information and a link bitmap shown in FIG. 9 to be described later. The link bitmap may be referred to as an ‘assigned link bitmap’.

The multi-link indication information may indicate a current scheme of using the multi-link. For example, the multi-link indication information may indicate the independent transmission scheme (e.g., the independent transmission scheme shown in FIG. 5A), a synchronous STR scheme, and/or a synchronous non-STR scheme. The synchronous STR scheme and the synchronous non-STR scheme may be the synchronization transmission scheme shown in FIG. 5B. When the synchronous STR scheme is used, STR operations may be performed based on the synchronization transmission scheme. When the synchronous non-STR scheme is used, non-STR operations may be performed based on the synchronization transmission scheme. The link bitmap may indicate information on link(s) (e.g., another link) in which data (e.g., MAC protocol data unit (MPDU)) is transmitted. In other words, the link bitmap may be used to indicate link(s) of the multi-link, in which the data frame is transmitted.

The multi-link indication information for the first link and the second link may be configured to indicate the synchronous STR scheme. When the multi-link includes eight links, the size of the link bitmap may be eight bits. A bit included in the link bitmap may indicate whether a data frame is transmitted in a link mapped to the corresponding bit. When data frames are transmitted in the first link and the second link, the link bitmap may be set to 1100000 in both the first link and the second link. In the link bitmap, the first bit may be mapped to the first link, and the second bit may be mapped to the second link. In other words, the above-described setting may indicate that MPDUs are simultaneously transmitted in the first link and the second link.

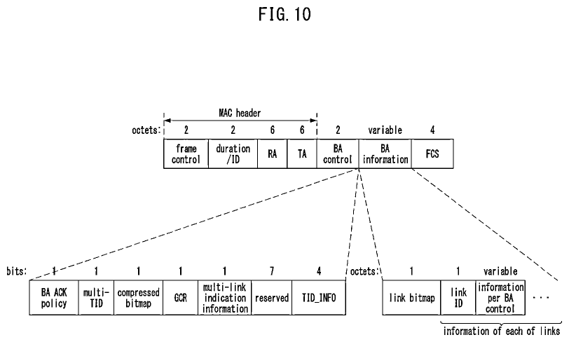

The distance between the AP and the STA may be less than or equal to the communicable distance of the first link and may exceed the communicable distance of the second link. Accordingly, the STA may receive the data frame from the AP in the first link and may not receive the data frame from the AP in the second link. Even in this case, the data frame received in the first link may include information of the data frame transmitted at the same time (e.g., the data frame transmitted in the second link). By setting an active link bitmap included in a multi-link (ML) ACK frame to 10000000, the STA may inform the AP of information on a link in which the data frame is received (hereinafter, referred to as ‘active link’). Here, the active link bitmap may be a link bitmap shown in FIG. 10 to be described later. When the multi-link includes eight links, the size of the active link bitmap may be eight bits. A bit included in the active link bitmap may indicate whether a frame can be received in a link mapped to the corresponding bit. A bit set to a first value (e.g., 1) in the active link bitmap may indicate that a link mapped to the corresponding bit is an active link. A bit set to a second value (e.g., 0) in the active link bitmap may indicate that a link mapped to the corresponding bit is a link in which a frame cannot be received (hereinafter, referred to as an ‘inactive link’).

In order to inform information on inactive link(s), the STA may measure a received signal level (e.g., received signal strength indication (RSSI)) in each of links, and when the received signal level is less than or equal to a preset threshold, the STA may determine the corresponding link as an inactive link. The STA may inform the AP of information on the inactive links by using the information (e.g., active link bitmap) included in the ML ACK frame. A received signal (e.g., received frame), which is a target for measuring the received signal level, may be a frame whose transmitter is the AP. If a frame is not decoded and a transmitter address (TA) thereof is unknown, a state of the corresponding link may be poor due to weak signal strength, and thus the corresponding link may be identified as an inactive link.

According to a TID of the data frame that is the target of the ACK frame, links that are targets of setting the inactive link information may be selected. For example, when a TID of the data frame received by the STA is 1, and links mapped to the TID 1 by TID-to-Link mapping are the link 1, link 2, and link 3, the inactive link setting operation may be performed for the corresponding links (e.g., links corresponding to the first bit, the second bit, and the third bit within the bitmap) after performing the above-described procedure for identifying the inactive links. After receiving the ACK frame, the AP may use only the inactive link setting values for the links corresponding to the TID of the data frame associated with the received ACK frame and may ignore values for other links (e.g., the fourth bit to the eighth bit).

The AP may receive the ML ACK frame from the STA and may identify active link(s) and/or inactive link(s) based on the active link bitmap included in the ML ACK frame. For example, the AP may determine that the first link is an active link and determine that the second link is an inactive link based on the active link bitmap. In this case, the AP may not perform a (re)transmission operation of the data frame in the second link. In other words, the AP may perform a (re)transmission operation of the data frame in the first link and/or other link(s) (e.g., link(s) other than the second link).

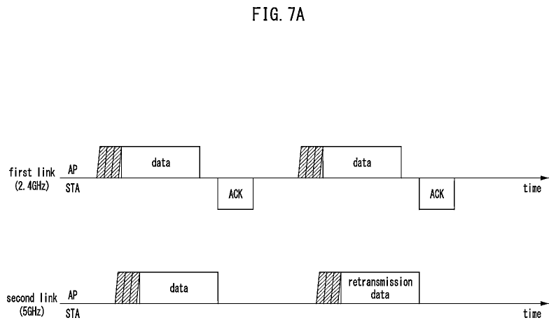

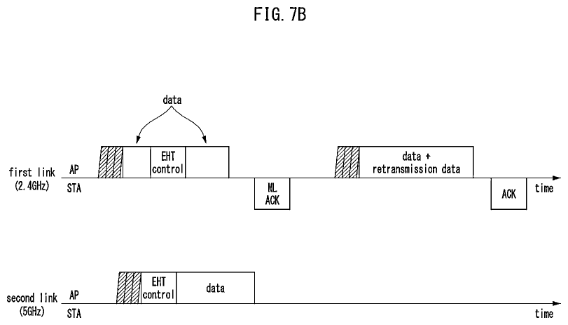

FIG. 7A is a timing diagram illustrating a first embodiment of a communication method based on the independent transmission scheme in a wireless LAN system, and FIG. 7B is a timing diagram illustrating a second embodiment of a communication method based on the independent transmission scheme in a wireless LAN system.

As shown in FIGS. 7A and 7B, a device may perform communication in the multi-link according to the independent transmission scheme. In the embodiment shown in FIG. 7A, an AP may independently transmit a data frame based on the independent transmission scheme in each of the first link and the second link. The frequency band of the first link may be the 2.4 GHz band, and the frequency band of the second link may be the 5 GHz band. In this case, the communicable distance of the first link may be longer than the communicable distance of the second link. Depending on a position of a STA receiving the data frame, the data frame may be successfully received by the STA without error in the first link, but in the second link, the data frame may not be received by the STA.

In the embodiment shown in FIG. 7A, the STA may receive the data frame from the AP in the first link and may transmit an ACK frame (or BA frame) for the data frame to the AP. The BA frame may be transmitted when a BAR frame is received from the AP. Alternatively, when an immediate response ACK policy is used, the BA frame may be transmitted without transmission of the BAR frame. When the ACK frame for the data frame is received in the first link, the AP may determine that the data frame has been successfully received by the STA.

The STA may not receive the data frame from the AP in the second link and thus may not be able to transmit an ACK frame (or BA frame) to the AP. When the ACK frame for the data frame is not received in the second link, the AP may determine that the reception of the data frame has failed at the STA. In this case, the AP may retransmit the data frame after a preset time (e.g., SIFS, PIFS, or a time until a start of data transmission in the first link). For example, if an ACK frame is not received for ‘SIFS+transmission period of ACK frame’ from a transmission end point of the data frame, the AP may determine that reception of the data frame has failed in the second link and may retransmit the data frame in the second link.

Alternatively, if a BA frame is not received for ‘SIFS+transmission period of BA frame’ from a transmission end point of the BAR frame, the AP may determine that reception of the data frame has failed in the second link and may retransmit the data in the second link. The data frame retransmission operation may be performed a preset number of times. If an ACK frame (or BA frame) for the data frame is not received even when the data frame is retransmitted the preset number of times, the AP may determine that the data frame transmission has failed and may stop the data frame retransmission operation.

In the embodiment shown in FIG. 7B, a MAC header of the data frame transmitted through the multi-link may include an EHT control field. The EHT control field may include multi-link indication information and a link bitmap (e.g., assigned link bitmap). When the independent transmission scheme is used and MPDUs are transmitted to the same receiver using the multi-link, bit(s) mapped to link(s) of the multi-link among bits included in the link bitmap may be set to 1. Each of MPDUs included in an A-MPDU transmitted in the first link may include a MAC header, and the MAC header may include an EHT control field. A link bitmap included in an EHT control field located at a transmission time of the second link may be set to 1100000. Since there is no data frame transmitted before the transmission time of the second link, a link bitmap of an EHT control field included in MAC headers of the previous MPDUs may be set to 10000000.

The distance between the AP and the STA may be less than or equal to the communicable distance of the first link and may exceed the communicable distance of the second link. Accordingly, the STA may receive the data frame from the AP in the first link and may not receive the data frame from the AP in the second link. Even in this case, the data frame received in the first link may include information of the data frame transmitted at the same time (e.g., the data frame transmitted in the second link). By setting an active link bitmap included in an ML ACK frame to 10000000, the STA may inform the AP of information on the active link. A bit set to a first value (e.g., 1) in the active link bitmap may indicate that a link mapped to the corresponding bit is an active link. A bit set to a second value (e.g., 0) in the active link bitmap may indicate that a link mapped to the corresponding bit is an inactive link.

In order to inform information on inactive link(s), the STA may measure a received signal level (e.g., RSSI) in each of the links, and when the received signal level is less than or equal to a preset threshold, the STA may set the corresponding link as an inactive link. The STA may inform the AP of information on the inactive links by using the information (e.g., active link bitmap) included in the ML ACK frame. A received signal (e.g., received frame), which is a target for measuring the received signal level, may be a frame whose transmitter is the AP. If a frame is not decoded and a transmitter address (TA) thereof is unknown, a state of the corresponding link may be poor due to weak signal strength, and thus the corresponding link may be identified as an inactive link.

According to a TID of the data frame that is the target of the ACK frame, links that are targets of setting the inactive link information may be selected. For example, when a TID of the data frame received by the STA is 1 and when links mapped to the TID 1 by TID-to-Link mapping are the link 1, link 2, and link 3, the inactive link setting operation may be performed for the corresponding links (e.g., links corresponding to the first bit, the second bit, and the third bit within the bitmap) after performing the above-described procedure for identifying the inactive links. After receiving the ACK frame, the AP may use only the inactive link setting values for the links corresponding to the TID of the data frame associated with the received ACK frame and may ignore values for other links (e.g., the fourth bit to the eighth bit).

The AP may receive the ML ACK frame from the STA and may identify active link(s) and/or inactive link(s) based on the active link bitmap included in the ML ACK frame. For example, the AP may determine that the first link is an active link and determine that the second link is an inactive link based on the active link bitmap. In this case, the AP may not perform a (re)transmission operation of the data frame in the second link. In other words, the AP may perform a (re)transmission operation of the data frame in the first link and/or other link(s) (e.g., link(s) other than the second link).

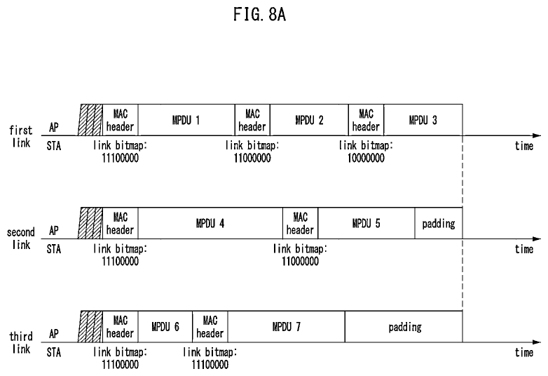

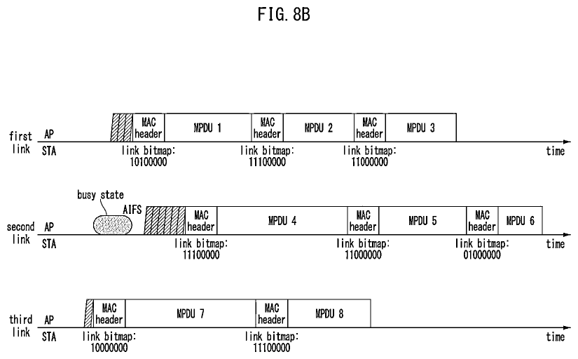

FIG. 8A is a timing diagram illustrating a third embodiment of a communication method using a multi-link in a wireless LAN system, and FIG. 8B is a timing diagram illustrating a fourth embodiment of a communication method using a multi-link in a wireless LAN system.

As shown in FIGS. 8A and 8B, a device may transmit data frames using the multi-link. In this case, a transmission state of the data frame in the multi-link may be indicated by a link bitmap (e.g., assigned link bitmap) of an EHT control field included in the data frame. In the embodiment shown in FIG. 8A, the synchronization transmission scheme may be used, and an A-MPDU may be transmitted in each link of the multi-link. The A-MPDU may include a plurality of MPDUs, and each of the plurality of MPDUs may include a MAC header. The MAC header may include the EHT control field including the link bitmap. When an MPDU (e.g., the MAC header of the MPDU) is transmitted in another link during a transmission period of an MPDU in the first link, bits mapped to the first link and the another link may be set to 1 among bits included in the link bitmap (e.g., the link bitmap included in the MPDU transmitted in the first link).

Since the synchronization transmission scheme is used in the embodiment shown in FIG. 8A, transmission operations may be started simultaneously in the first link, the second link, and the third link. MPDU(s) may be transmitted in other link(s) at a transmission time of MPDU(s) in one link. Therefore, the link bitmap may be set to 11100000. Since only a MAC header of an MPDU 5 is transmitted in the second link during a transmission period of an MPDU 2, a link bitmap included in a MAC header of the MPDU 2 may be set to 1100000. Since only a MAC header of an MPDU 3 is transmitted in the first link during a transmission period of the MPDU 5, a link bitmap included in a MAC header of the MPDU 5 may be set to 1100000. Since the MAC header of the MPDU 2 and the MAC header of the MPDU 5 are transmitted in the second link during a transmission period of an MPDU 7, a link bitmap included in a MAC header of the MPDU 7 may be set to 11100000.

In the embodiment shown in FIG. 8A, padding may be added to match the transmission end times of the data frames through the multi-link (e.g., the first link, the second link, and the third link).

In the embodiment shown in FIG. 8B, the independent transmission scheme may be used. In the embodiment shown in FIG. 8B, link bitmaps included in MAC headers of MPDUs may be set identically or similarly to the embodiment shown in FIG. 8A.

FIG. 9 is a block diagram illustrating a first embodiment of a data frame including information indicating transmission states of a multi-link in a wireless LAN system.

As shown in FIG. 9, a MAC header of an MPDU may include an EHT control field. A type field and a subtype field may indicate whether the MAC header of the corresponding MPDU includes the EHT control field. In other words, a combination of a value of the type field and a value of the subtype field may indicate that the corresponding MPDU includes data transmitted through the multi-link (e.g., EHT multi-link data). The type field set to 10 and the subtype field set to 1101 may indicate EHT multi-link data. When the type field and the subtype field indicate the EHT multi-link data, the corresponding MPDU may include the EHT control field. The EHT control field may include multi-link indication information and/or a link bitmap (e.g., assigned link bitmap).

The multi-link indication information may indicate a multi-link usage scheme. For example, the multi-link indication information may indicate the independent transmission scheme, the synchronous STR scheme, and/or the synchronous non-STR scheme. For example, the multi-link indication information set to 00 may indicate that the independent transmission scheme is used, the multi-link indication information set to 01 may indicate that the synchronous STR scheme is used, and the multi-link indication information set to 11 may indicate that the synchronous non-STR scheme is used.

When the independent transmission scheme is used, a transmission operation in another link may be performed based on the independent transmission scheme. When the synchronous STR scheme is used, STR operations may be performed based on the synchronization transmission scheme. When the synchronous non-STR scheme is used, non-STR operations may be performed based on the synchronization transmission scheme.

The link bitmap may indicate information on link(s) (e.g., another link) in which data (e.g., MPDU, MAC header of the MPDU) is transmitted. When the multi-link supported by one device includes eight links, the link bitmap may include eight bits. One bit included in the link bitmap may be mapped to one link. A bit set to a first value (e.g., 1) may indicate that transmission of an MPDU (e.g., a MAC header of the MPDU) is performed in a link mapped to the corresponding bit. A bit set to a second value (e.g., 0) may indicate that transmission of an MPDU (e.g., a MAC header of the MPDU) is not performed in a link mapped to the corresponding bit. For example, the link bitmap set to 11100001 may indicate that transmission of an MPDU (e.g., a MAC header of the MPDU) is performed in the first link, the second link, the third link, and the eighth link.

FIG. 10 is a block diagram illustrating a first embodiment of a BA frame including information indicating reception states of a multi-link in a wireless LAN system.

As shown in FIG. 10, a BA frame (or ACK frame, ML ACK frame, or ML BA frame) may be used to inform reception states of data frames in the multi-link. A BA control field of the BA frame may include multi-link indication information, and a BA information field of the BA frame may include a link bitmap. The link bitmap included in the BA frame may be referred to as an ‘active link bitmap’. The active link bitmap may be distinguished from the assigned link bitmap included in the data frame (i.e., the frame shown in FIG. 9). When the multi-link indication information is set to 1, a BA type may be indicated according to a combination of other fields. The BA type may be configured as shown in Table 1 below. Information included in the BA information field (e.g., multi-link BA information field) of the BA frame may vary according to the BA type.

TABLE 1

| | | | Multi-link | |
|---|---|---|---|---|
| Multi- | Compressed | | indication | |
| TID | bitmap | GCR | information | BA type |
| 0 | 0 | 0 | 1 | Multi-link basic BA |
| 0 | 1 | 0 | 1 | Multi-link compressed BA |
| 1 | 0 | 0 | 1 | Multi-link extended |
| | | | | compressed BA |
| 1 | 1 | 0 | 1 | Multi-link multi-TID BA |
| 0 | 1 | 1 | 1 | Multi-link GCR BA |

The link bitmap may be used to indicate link(s) in which the data frame associated with the BA frame is received. When the data frame is received in the link indicated by the assigned link bitmap or when a received signal level (or received signal quality) in the link is greater than or equal to a preset threshold (e.g., RSSI), a link bitmap (i.e., active link bitmap) indicating the corresponding link may be included in the BA frame. The BA frame may include one link bitmap, and a link identifier (ID) and/or information per BA control of each of the links indicated by the link bitmap may be included in the BA frame. For example, the link bitmap may indicate that the first link, the second link, and the third link are active. In this case, the BA frame may include ‘link ID and/or information per BA control of the first link, ‘link ID and/or information per BA control of the second link’, and ‘link ID and/or information per BA control of the third link.

The embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those having ordinary skill in the art.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first device in a communication system, the operation method comprising:
generating a data frame including first information indicating a communication scheme in a multi-link including a first link and a second link;
transmitting the data frame to a second device in the multi-link; and
receiving an acknowledgment (ACK) frame for the data frame from the second device in one or more links of the multi-link.

2. The operation method according to claim 1, wherein the communication scheme indicates an independent transmission scheme or a synchronization transmission scheme, a communication operation is performed independently in each link of the multi-link when the independent transmission scheme is used, and synchronous communication operations are performed in the multi-link when the synchronization transmission scheme is used

3. The operation method according to claim 2, wherein the synchronization transmission scheme is classified into a synchronous simultaneous transmit and receive (STR) scheme and a synchronous non-STR scheme, STR operations are performed in the multi-link when the synchronous STR scheme is used, and the STR operations are not performed in the multi-link when the synchronous non-STR scheme is used.

4. The operation method according to claim 1, wherein the data frame further includes second information indicating one or more links of the multi-link, in which the data frame is transmitted.

5. The operation method according to claim 4, wherein the first information and the second information are included in an extremely high throughput (EHT) control field of a medium access control (MAC) header of the data frame.

6. The operation method according to claim 5, wherein when a combination of a value of a type field and a value of a subtype field included in the MAC header of the data frame is a first value, the MAC header includes the EHT control field.

7. The operation method according to claim 1, wherein the ACK frame includes third information indicating one or more links of the multi-link, in which the data frame is received.

8. The operation method according to claim 7, wherein the ACK frame further includes an identifier (ID) of each of the one or more links indicated by the third information.

9. The operation method according to claim 7, further comprising, when the third information indicates that the data frame is received in the first link and the data frame is not received in the second link, transmitting a data frame including retransmission data for the second link in the first link.

10. An operation method of a second device in a communication system, the operation method comprising:
receiving a data frame from a first device in one or more links of a multi-link including a first link and a second link;
generating an acknowledgment (ACK) frame including third information indicating the one or more links in which the data frame is received; and
transmitting the ACK frame to the first device in the one or more links.

11. The operation method according to claim 10, wherein the data frame includes first information indicating a communication scheme in the multi-link and second information indicating one or more links of the multi-link, in which the data frame is transmitted.

12. The operation method according to claim 11, wherein the communication scheme indicates an independent transmission scheme or a synchronization transmission scheme, a communication operation is performed independently in each link of the multi-link when the independent transmission scheme is used, and synchronous communication operations are performed in the multi-link when the synchronization transmission scheme is used.

13. The operation method according to claim 11, wherein the first information and the second information are included in an extremely high throughput (EHT) control field of a medium access control (MAC) header of the data frame.

14. The operation method according to claim 10, wherein the ACK frame further includes an identifier (ID) of each of the one or more links indicated by the third information.

15. The operation method according to claim 10, further comprising, when the third information indicates that the data frame is received in the first link and the data frame is not received in the second link, receiving, from the first device, a data frame including retransmission data for the second link in the first link.

16. A first device in a communication system, comprising:
a processor; and
a memory storing one or more instructions executable by the processor,
wherein the one or more instructions are executed to:
generate a data frame including second information indicating one or more links of a multi-link, in which the data frame is transmitted, the multi-link including a first link and a second link;
transmit the data frame to a second device in the one or more links indicated by the second information; and
receive an acknowledgment (ACK) frame for the data frame from the second device in at least one link of the multi-link.

17. The first device according to claim 16, wherein the data frame further includes first information indicating a communication scheme in the multi-link, the communication scheme indicates an independent transmission scheme or a synchronization transmission scheme, a communication operation is performed independently in each link of the multi-link when the independent transmission scheme is used, and synchronous communication operations are performed in the multi-link when the synchronization transmission scheme is used.

18. The first device according to claim 17, wherein the first information and the second information are included in an extremely high throughput (EHT) control field of a medium access control (MAC) header of the data frame.

19. The first device according to claim 16, wherein the ACK frame includes third information indicating one or more links of the multi-link, in which the data frame is received.

20. The first device according to claim 19, wherein the one or more instructions are further executed to, when the third information indicates that the data frame is received in the first link and the data frame is not received in the second link, transmit a data frame including retransmission data for the second link in the first link.
